(19) United States
(12) Patent Application Publication
(10) Pub. No.: US 2026/0138030 A1
(43) Pub. Date: May 21, 2026

(54) INFERENCE-BASED MOVE SELECTION USING PREDICTIVE CONTROL FOR GAME-PLAYING APPLICATIONS

(71) Applicants: Dimitri Bertsekas, Belmont, MA (US); Yuchao Li, Tempe, AZ (US); Atharva Gundawar, Manteca, CA (US)

(72) Inventors: Dimitri Bertsekas, Belmont, MA (US); Yuchao Li, Tempe, AZ (US); Atharva Gundawar, Manteca, CA (US)

(73) Assignee: Arizona Board of Regents on Behalf of Arizona State University, Scottsdale, AZ (US)

(21) Appl. No.: 19/396,092

(22) Filed: Nov. 20, 2025

Related U.S. Application Data
(60) Provisional application No. 63/723,443, filed on Nov. 21, 2024.

(51) Int. Cl. A63F 13/67; A63F 13/822

(52) U.S. Cl. CPC A63F 13/67; A63F 13/822

(57) ABSTRACT

An inference-based move selection technique is disclosed for a game-playing system executed by one or more computing devices. The processing circuitry determines a current game position represented as digital state data and, for each legal move, generates a predicted opponent move using a nominal opponent engine that outputs a move expected to be selected by an opponent. A position evaluator engine evaluates each resulting game position to obtain numerical evaluation values. The processing circuitry determines a preferred move based on the evaluation values and outputs control data defining the next move to be executed in the game. The approach enables predictive decision-making through coordinated evaluation of potential player and opponent actions using preexisting engines within a unified inference framework.

### CLAIM OF PRIORITY

This application claims the benefit of U.S. Provisional Patent Application No. 63/723,443, filed 21 Nov. 2024, the entire contents of which is incorporated herein by reference.

### TECHNICAL FIELD

Aspects of the disclosure relate generally to machine learning, augmented intelligence, and artificial intelligence, and more particularly to computational techniques involving predictive modeling, control optimization, and reinforcement-based evaluation within digital processing environments.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to embodiments of the claimed inventions. Machine learning, augmented intelligence, and artificial intelligence are areas of computer science concerned with enabling digital systems to analyze data, identify patterns, and make informed decisions. Artificial intelligence generally refers to computational methods that replicate or approximate aspects of human cognition, including reasoning, planning, and perception. Augmented intelligence focuses on complementing human expertise with algorithmic assistance to improve accuracy and efficiency in decision-making processes. Machine learning applies statistical and computational models that adapt and improve performance based on data exposure rather than explicit programming. Within machine learning, reinforcement learning enables iterative improvement through feedback-driven optimization of actions in simulated or real environments. Conventional reinforcement learning systems often employ policy evaluation, simulation, and rollout techniques to assess the potential outcomes of alternative actions, forming the basis of many modern control, planning, and game-playing applications.

### SUMMARY

In general, techniques are described for performing inference-based move selection in a game-playing system executed by one or more computing devices. The processing circuitry determines a current game position that it represents as digital state data. For each legal move available from the current position, the system generates a predicted opponent move using a nominal opponent engine configured to process the digital state data and output a move expected to be selected by an opponent. A position evaluator engine evaluates each subsequent game position that would result from the predicted opponent move to obtain corresponding numerical evaluation values. Based on the evaluation values, the processing circuitry determines a preferred move associated with an optimal evaluation value and outputs control data defining the next move to be executed in the game. Examples may include the use of model predictive control, rollout operations, or reinforcement-trained neural networks for adaptive evaluation and decision processes.

According to one example, a method for performing inference-based move selection in a game-playing system executed by one or more computing devices includes determining, by processing circuitry of the one or more computing devices, a current game position that the processing circuitry represents as digital state data. In one example, the method further includes generating, for each legal move from the current game position, a predicted opponent move responsive to the legal move using a nominal opponent engine configured to receive the digital state data and to output a move predicted to be selected by an opponent. In another example, the method includes evaluating, by a position evaluator engine executed by the processing circuitry, each subsequent game position that results from the predicted opponent move to obtain corresponding numerical evaluation values. According to such examples, the method also includes determining, based on the numerical evaluation values, a preferred move associated with an optimal evaluation value. In at least one example, the method includes outputting, by the processing circuitry, the preferred move as control data defining a next move to be executed in the game.

According to another example, a system includes processing circuitry, non-transitory computer-readable storage media, and instructions that, when executed by the processing circuitry, configure the processing circuitry to determine a current game position that the processing circuitry represents as digital state data. In one example, the system generates, for each legal move from the current game position, a predicted opponent move responsive to the legal move using a nominal opponent engine configured to receive the digital state data and to output a move predicted to be selected by an opponent. According to such examples, the system evaluates, using a position evaluator engine executed by the processing circuitry, each subsequent game position that results from the predicted opponent move to obtain corresponding numerical evaluation values. In at least one example, the system determines, based on the numerical evaluation values, a preferred move associated with an optimal evaluation value. The system outputs, by the processing circuitry, the preferred move as control data defining a next move to be executed in the game.

According to yet another example, non-transitory computer-readable storage media comprise instructions that, when executed by processing circuitry, cause the processing circuitry to determine a current game position that the processing circuitry represents as digital state data. In one example, the storage media cause the processing circuitry to generate, for each legal move from the current game position, a predicted opponent move responsive to the legal move using a nominal opponent engine configured to receive the digital state data and to output a move predicted to be selected by an opponent. In another example, the storage media cause the processing circuitry to evaluate, using a position evaluator engine executed by the processing circuitry, each subsequent game position that results from the predicted opponent move to obtain corresponding numerical evaluation values. In at least one example, the storage media cause the processing circuitry to determine, based on the numerical evaluation values, a preferred move associated with an optimal evaluation value. According to such examples, the storage media cause the processing circuitry to output the preferred move as control data defining a next move to be executed in the game.

According to a particular example, there is a device which includes means for determining, by processing circuitry of one or more computing devices, a current game position that the processing circuitry represents as digital state data. The device further includes means for generating, for each legal move from the current game position, a predicted opponent move responsive to the legal move using a nominal opponent engine configured to receive the digital state data and to output a move predicted to be selected by an opponent. The device includes means for evaluating, by a position evaluator engine executed by the processing circuitry, each subsequent game position that results from the predicted opponent move to obtain corresponding numerical evaluation values. The device also includes means for determining, based on the numerical evaluation values, a preferred move associated with an optimal evaluation value. The device includes means for outputting, by the processing circuitry, the preferred move as control data defining a next move to be executed in the game.

The details of one or more examples of the disclosure are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating further details of one example of a computing device, in accordance with aspects of this disclosure.

FIG. 2 depicts an example of a model predictive control-meta chess (MPC-MC) framework with a one-step lookahead, in accordance with aspects of this disclosure.

FIG. 3 depicts Table 1, providing test results for a deterministic model predictive control-meta chess (MPC-MC) framework, in accordance with aspects of this disclosure.

FIG. 4 depicts Table 2, providing test results for a stochastic model predictive control-meta chess (MPC-MC) framework, in accordance with aspects of this disclosure.

FIG. 5 depicts a schematic illustration of a model predictive control-meta chess (MPC-MC) framework with half-step lookahead, in accordance with aspects of this disclosure.

FIG. 6 depicts Table 3, providing test results for a stochastic model predictive control-meta chess (MPC-MC) framework, in accordance with aspects of this disclosure.

FIG. 7 depicts a schematic illustration of a model predictive control-meta chess (MPC-MC) framework with two-step lookahead and a deterministic nominal opponent, in accordance with aspects of this disclosure.

FIG. 8 depicts Table 4, providing test results for a model predictive control-meta chess (MPC-MC) framework with two-step lookahead, in accordance with aspects of this disclosure.

FIG. 9 is a flow diagram illustrating an example method for performing inference-based move selection in a game-playing system, in accordance with aspects of this disclosure.

### DETAILED DESCRIPTION

In general, techniques are described for performing inference-based move selection in a game-playing system executed by one or more computing devices. The processing circuitry determines a current game position that it represents as digital state data. For each legal move available from the current position, the system generates a predicted opponent move using a nominal opponent engine configured to process the digital state data and output a move expected to be selected by an opponent. A position evaluator engine evaluates each subsequent game position that would result from the predicted opponent move to obtain corresponding numerical evaluation values. Based on the evaluation values, the processing circuitry determines a preferred move associated with an optimal evaluation value and outputs control data defining the next move to be executed in the game. Examples may include the use of model predictive control, rollout operations, or reinforcement-trained neural networks for adaptive evaluation and decision processes.

Building upon these general techniques, certain examples implement a model predictive control and Monte Carlo (MPC-MC) framework that applies reinforcement learning and rollout methodologies to game-playing scenarios such as computer chess. In one example, the MPC-MC framework executes two chess engines to generate possible moves from a given chess position and to evaluate resulting finishing positions from the perspective of each engine acting as an opposing player.

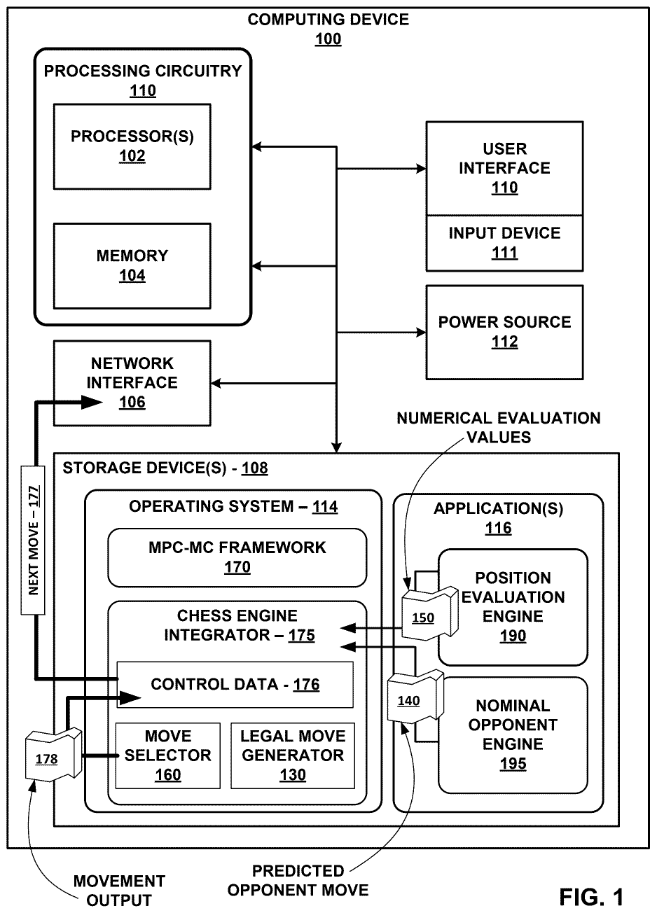

FIG. 1 is a block diagram illustrating further details of one example of computing device, in accordance with aspects of this disclosure. FIG. 1 illustrates only one particular example of computing device 100. Many other examples of computing device 100 may be used in other instances.

As shown in the specific example of FIG. 1, computing device 100 may include one or more processors 102, memory 104, network interface 106, one or more storage devices 108, user interface 110, input device 111, and power source 112. Computing device 100 may also include operating system 114 and one or more applications 116. Applications 116 may include position evaluation engine 190 and nominal opponent engine 195 configured to simulate the decision-making behavior of game opponents. In one example, these components cooperate to perform inference-based move selection within a game-playing environment.

Operating system 114 may execute various functions of MPC-MC framework 170 in conjunction with position evaluation engine 190 and nominal opponent engine 195 to perform predictive gameplay using data representing a current game position. Processing circuitry including one or more processors 102 may represent the current game position as digital state data that is received by nominal opponent engine 195, which may generate a predicted opponent move for each legal move identified by legal move generator 130.

Position evaluation engine 190 may evaluate each resulting game position and output corresponding numerical evaluation values to chess engine integrator 175. Control data 176 may determine a preferred move associated with an optimal evaluation value, and such preferred move may correspond to next move 177 output from computing device 100 for execution within the game environment. In some implementations, chess engine integrator 175 may also exchange information with move selector 160 to identify configuration-dependent adjustments and generate predicted opponent move feedback to MPC-MC framework 170.

In some implementations, control data 176 may represent structured digital information output by move selector 160 indicating one or more candidate moves ranked according to evaluation criteria received from position evaluation engine 190. Position evaluation engine 190 may produce numerical evaluation values representing a scalar measure of relative advantage for each predicted opponent move generated by nominal opponent engine 195. These numerical evaluation values may be supplied to MPC-MC framework 170, which determines a preferred move associated with an optimal evaluation value. Move selector 160 may compare each candidate move's evaluation result and identify the preferred move to be encoded as control data 176. Next move 177 may correspond to that preferred move and may be transmitted as digital control output to additional modules or external systems that execute gameplay. In some examples, the predicted opponent move generated by nominal opponent engine 195 may be derived using a lookahead search based on digital state data representing a current game position. Such data exchange between processing circuitry 102, nominal opponent engine 195, and position evaluation engine 190 may be implemented synchronously or in parallel to improve computational efficiency within MPC-MC framework 170.

In additional implementations, MPC-MC framework 170 may execute prediction and evaluation cycles using distributed or parallel processing architectures to reduce total computation time. Processing circuitry 102 may divide the evaluation of legal moves among multiple cores, processors, or networked computing nodes, each node performing move generation, opponent-response prediction, and position evaluation for an assigned subset of legal moves. The results may be aggregated by chess engine integrator 175 and provided to move selector 160 for determination of the preferred move. Parallelization enables approximately 2 m operations per evaluation cycle, where m represents the number of legal moves, to be performed within a time comparable to a single-engine evaluation when sufficient computing resources are available. In some configurations, the distributed processing arrangement may employ message-passing interfaces or cloud-based task schedulers to achieve near-linear scaling efficiency during inference-based move selection.

Processing circuitry including one or more processors 102 implements functionality and/or process instructions for execution within computing device 100. For example, one or more processors 102 may be capable of processing instructions stored in memory 104 and/or instructions stored on one or more storage devices 108.

Memory 104, in one example, may store information within computing device 100 during operation. Memory 104 may represent a computer-readable storage medium and, in some examples, may be a temporary or volatile memory. Examples of volatile memory may include random access memory (RAM), dynamic random-access memory (DRAM), static random-access memory (SRAM), or other types of volatile memory. Memory 104 may store program instructions for execution by one or more processors 102 and may be used by software or applications 116 to temporarily store data and instructions during execution.

One or more storage devices 108 may also include one or more computer-readable storage media configured for long-term storage of information. Examples may include magnetic hard disks, optical discs, flash memories, or electrically programmable and erasable memories (EPROM, EEPROM). Storage devices 108 may further store operating system 114, MPC-MC framework 170, and any data defining control parameters for chess engine integrator 175 and related components.

Computing device 100 may also include network interface 106 configured to communicate with external systems via one or more networks. Network interface 106 may include wired or wireless transceivers such as Ethernet, BLUETOOTH®, LTE, or WI-FI® radios, enabling computing device 100 to exchange game data, configuration data, or evaluation metrics with remote servers or other computing nodes.

User interface 110 may include one or more input devices 111 such as a touch-sensitive display, keyboard, or voice-responsive system. Input device 111 may receive user commands or configuration data for gameplay control. User interface 110 may also include one or more output devices, such as a display or speaker, to provide tactile, audio, or visual feedback regarding the game state, numerical evaluation values, and next move 177.

Power source 112 may provide operating power to computing device 100 and, in some examples, may include a rechargeable battery formed from lithium-ion, nickel-cadmium, or other suitable materials.

Operating system 114 may control the operation of components within computing device 100 and may facilitate interaction of one or more applications 116 with hardware resources. Operating system 114 may manage data exchange among MPC-MC framework 170, chess engine integrator 175, move selector 160, legal move generator 130, position evaluation engine 190, and nominal opponent engine 195 to support inference-based move prediction and selection processes as described above. The described MPC-MC framework can, in some implementations, be extended to other two-player zero-sum games employing similar digital state evaluation and move prediction strategies.

In some examples, computing device 100 and MPC-MC framework 170 may also be configured as a distributed system that executes predictive-control operations across multiple computing nodes or heterogeneous processors. Each node may execute a portion of nominal opponent engine 195 and position evaluation engine 190 while exchanging intermediate results through chess engine integrator 175. Processing circuitry 102 may aggregate the distributed evaluations to determine a preferred control action or move associated with an optimal numerical evaluation value. The system architecture may further include non-transitory computer-readable storage media storing instructions that, when executed, cause the distributed processing units to perform prediction and evaluation tasks in parallel and to output control data defining the next action to be executed. This arrangement supports deployment of MPC-MC framework 170 not only in digital gameplay contexts but also in continuous or hybrid predictive-control environments such as robotic coordination, adaptive simulation, and autonomous system management.

In some examples, the techniques executed by computing device 100 may also apply to predictive-control systems beyond discrete game environments. The processing circuitry 102 may operate in conjunction with MPC-MC framework 170 to evaluate candidate control actions within a dynamic system, where a nominal opponent engine 195 represents a modeled disturbance or adversarial process. Position evaluation engine 190 may estimate a scalar cost or performance function associated with each potential response, and chess engine integrator 175 may aggregate distributed evaluations performed across multiple processors or networked computing nodes. This distributed predictive-control architecture may be configured to operate in parallel across heterogeneous hardware such as CPUs, GPUs, or tensor-processing units, enabling near-real-time inference of optimal control actions for diverse applications including robotic motion planning, adaptive resource allocation, or simulation-based strategy analysis.

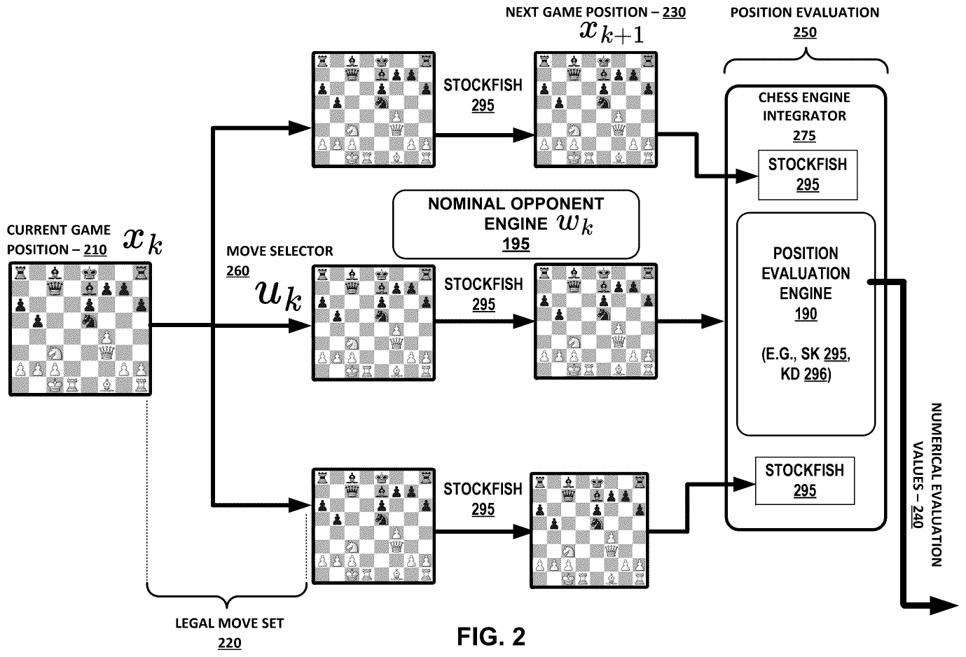

FIG. 2 depicts an example of model predictive control-meta chess (MPC-MC) framework 170 with one-step lookahead, in accordance with aspects of this disclosure. FIG. 2 illustrates the interaction among current game position 210, legal move set 220, move selector 260, nominal opponent engine 195, position evaluation engine 190, and chess engine integrator 275, along with the generation of numerical evaluation values 240 that support inference-based move selection.

Current game position 210 represents digital state data defining a board configuration at a given time step k, denoted xₖ. Move selector 260 identifies a candidate move uₖ from legal move set 220, where each move corresponds to a potential transition from current game position 210 to a subsequent position in the game space. Nominal opponent engine 195 receives digital state data representing current game position 210 together with candidate move uₖ and outputs a predicted opponent response wₖ. The predicted opponent response wₖ corresponds to an inferred move that a simulated or modeled opponent may select under similar conditions.

Each predicted opponent response wₖ results in a new game configuration evaluated by position evaluation engine 190. In one example, position evaluation engine 190 is integrated within chess engine integrator 275 and may execute one or more chess engines such as Stockfish 295 or other evaluators, such as Komodo Dragon 296, to generate position scores. These scores may represent numerical evaluation values 240 corresponding to an assessment of the resulting board position's advantage or disadvantage. Position evaluation 250 thus produces numerical evaluation values 240 that quantify performance outcomes for each candidate move uₖ and its associated predicted opponent move wₖ.

Next game position 230, denoted xₖ₊₁, represents the digital state data corresponding to the position that would result if the preferred move uₖ were executed followed by the predicted opponent response wₖ. MPC-MC framework 170 determines the preferred move by comparing the numerical evaluation values 240 for all legal moves within legal move set 220. Move selector 260 identifies the move associated with the optimal evaluation value and outputs data indicating that selection to the control logic of computing device 100 for execution as next move 177 in FIG. 1.

In some implementations, nominal opponent engine 195 and position evaluation engine 190 may execute concurrently to evaluate multiple potential sequences in parallel, improving throughput during prediction and evaluation cycles. Stockfish 295 shown in FIG. 2 represents one example of a lower-level engine integrated through chess engine integrator 275, although other engines such as SK 295 or KD 296 may also be used to implement position evaluation 250. The resulting architecture enables efficient inference-based decision making by iteratively evaluating predicted outcomes and selecting the move sequence most consistent with optimal numerical evaluation values 240.

Following the discussion of FIG. 2, further context is provided regarding the theoretical foundation and practical development of MPC-MC framework 170 and its relationship to prior computer-chess methodologies. The origins of modern computer-chess trace to foundational work by Claude Shannon, who proposed that the outcome of a starting chess position could, in principle, be determined through an exhaustive minimax search extending to game termination. This minimax concept established a basis for dynamic programming and control optimization in adversarial settings. Recognizing the computational difficulty of full-tree evaluation, Shannon described a limited lookahead strategy that evaluates terminal nodes using a scoring function and selects a move associated with a favorable propagated score. This limited-horizon concept forms a conceptual basis for many computer-chess systems in use today. Contemporary engines, such as Stockfish 795, incorporate refined implementations of these principles and may be executed by position evaluation engine 190 or nominal opponent engine 195 within MPC-MC framework 170.

To improve computational efficiency, Shannon introduced the notion of selective pruning, referred to as a type B strategy, distinguishing it from type A strategies that attempt exhaustive search except for pruning used to eliminate redundancy (e.g., alpha-beta pruning). Over time, hybrid combinations of type A and type B strategies have become standard in chess engines. Research by van den Herik and others in artificial intelligence and computer chess chronicles how these techniques evolved through successive generations of engines.

Next position 730 represents digital state data defining the game configuration that results from execution of candidate move uₖ and predicted opponent response wₖ. Next position 730 includes complete board-state information, turn indicators, and auxiliary metadata such as castling rights, repetition counters, or move-history identifiers used by nominal opponent engine 795 and position evaluation engine 790 for subsequent evaluation. In some implementations, next position 730 may be stored temporarily within memory associated with move selector 760 or transferred directly to position evaluation engine 790 for generation of numerical evaluation values 740 corresponding to that position.

Beginning in the 1960s, systematic study of tree search and pruning heuristics advanced in both chess and machine learning contexts. In 2017, the position evaluation 250 methodology experienced a paradigm shift with the introduction of the AlphaZero engine, which used deep neural networks trained through self-play and reinforcement-based improvement to generate position evaluators. This policy-iteration-based approach, combined with Monte Carlo tree search for adaptive pruning, exemplified Shannon's type B principle implemented through modern reinforcement learning. Similar architectures were later employed in systems such as Leela Chess Zero.

Subsequent developments also refined traditional engines. The Stockfish program, which AlphaZero initially defeated, was later enhanced through neural network-based position evaluation, enabling near-perfect play. Komodo Dragon, another state-of-the-art engine, follows comparable principles and has achieved multiple world-championship titles. Extensive literature and open-source resources describe these engines and their evaluation functions.

Building upon these foundations, MPC-MC framework 170 introduces a model predictive control (MPC)-based architecture to the domain of computer chess. Model predictive control is a control-theoretic approach that employs predictive modeling to optimize future actions over a defined horizon while satisfying constraints. MPC-MC framework 170 applies this predictive optimization concept to move selection, representing a significant conceptual shift from static minimax evaluation toward adaptive control-driven inference.

There exists a strong conceptual connection between model predictive control and the reinforcement learning principle of approximation in value space, which underlies rollout algorithms and single-policy iteration schemes. MPC-MC framework 170 integrates these concepts by linking existing chess engines to a unified predictive evaluation process through chess engine integrator 175, combining type A strategies executed by position evaluation engine 190 with type B strategies inherently used by nominal opponent engine 195. The result is a hybridized predictive-control structure capable of both deterministic evaluation and adaptive response modeling.

Viewed abstractly, MPC-MC framework 170 functions as a meta-algorithm, an algorithm operating upon other algorithms, to coordinate multiple lower-level chess engines executed by nominal opponent engine 195. The term “Meta Chess” reflects this hierarchical integration. From a theoretical standpoint, MPC-MC framework 170 leverages a synergistic combination of offline-trained position evaluation 250 functions generated by position evaluation engine 190 and an online optimization process governed by the Newton method. In this context, the Newton method operates as an iterative numerical optimizer that refines position evaluations 250 and accelerates convergence of control decisions. Its application within MPC-MC framework 170 enables more accurate and computationally efficient evaluation of chess positions, enhancing overall strategic precision.

Experimental analysis demonstrates that MPC-MC framework 170 provides measurable performance gains over pre-existing systems by embedding any compatible chess engine, commercial or open-source, within its predictive-control structure. In practice, chess engines executed via nominal opponent engine 195 and integrated through chess engine integrator 175 exhibit substantial improvement relative to their baseline performance outside of MPC-MC framework 170. For instance, implementations based on Stockfish engines executing within nominal opponent engine 195 consistently outperform standalone Stockfish engines, particularly under constrained time limits, while maintaining parity at near-optimal time horizons.

The general structure and computational characteristics of MPC-MC framework 170 extend naturally beyond chess to other deterministic two-player zero-sum games such as Shogi, Xiangqi, Checkers, Go, and Reversi. By adapting nominal opponent engine 195 to the respective rule sets of these games, similar performance benefits may be achieved through the same predictive-control integration.

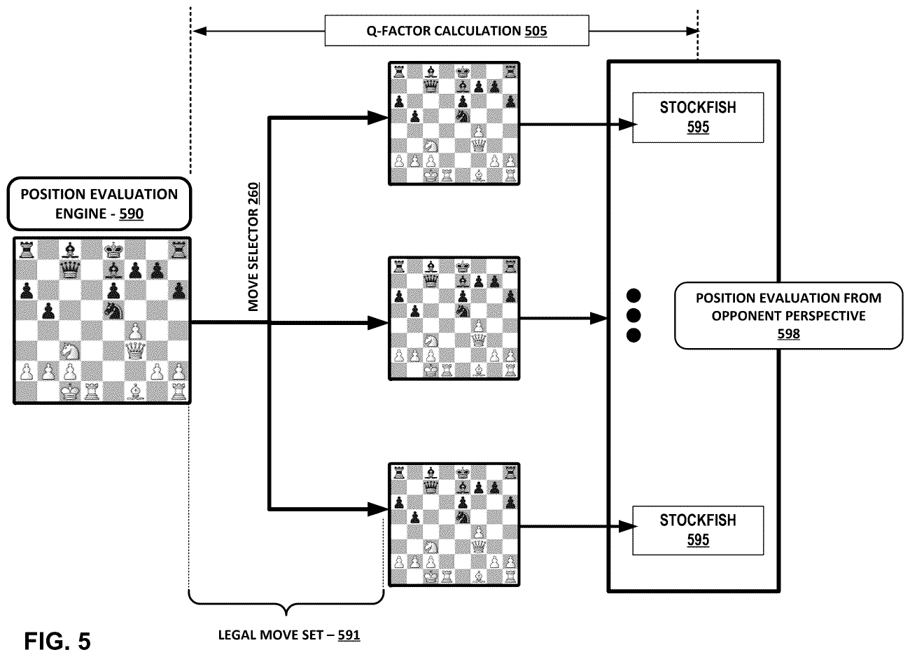

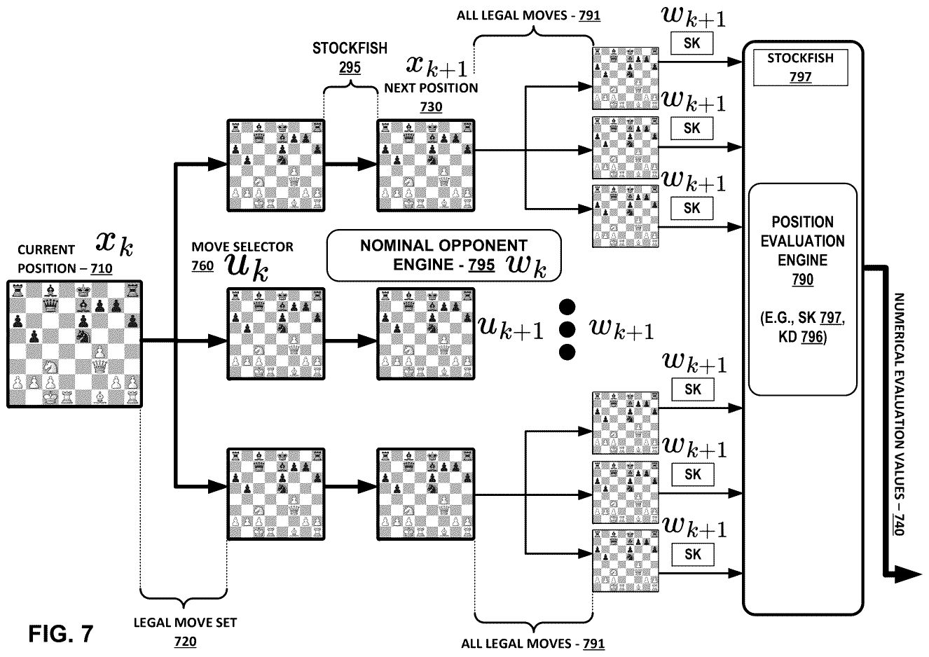

MPC-MC framework 170 is described below in its one-step lookahead configuration (see FIG. 2). The following sections also address deterministic and stochastic variants corresponding to known and unknown opponent behavior, as well as a fortified variant that mitigates truncation errors common in rollout algorithms. Experimental data and half-step and multistep lookahead implementations (see FIGS. 5 and 7) are further described, demonstrating progressively deeper inference at the expense of additional computation.

With continued reference to FIG. 2, the operational architecture of MPC-MC framework 170 may be described beginning from a given chess position denoted x. A conventional chess engine generally determines a move through a multistep minimax search that is typically approximate due to pruning of the lookahead tree. By contrast, MPC-MC framework 170 incorporates predictive control logic enabling integration of both a position evaluation engine 190 and a nominal opponent engine 195 through chess engine integrator 175. In one configuration, a grandmaster-level chess engine employing a neural network position evaluator comprising approximately 270 million parameters may serve as nominal opponent engine 195 for purposes of generating candidate responses and supporting inference-based prediction.

In particular, nominal opponent engine 195 produces a numerical evaluation Q(x,u) corresponding to the position that would result from current position x after each legal move u, and selects a move ũ that yields the best evaluation outcome. In reinforcement learning (RL) terminology, Q(x,u) represents the Q-factor associated with the state-action pair (x,u). According to some examples, MPC-MC framework 170 assumes that smaller Q-factors correspond to more favorable moves. Thus, in such an example, MPC-MC framework 170 may utilize a pre-existing chess engine executing via nominal opponent engine 195, which is viewed as a function μ that, when faced with position x, plays the move μ(x)=ũ, where:

$$\tilde{u} ∈ arg {min}_{u ∈ L ( x )} Q ( x , u ) ,$$

with L(x) denoting the set of legal moves at position x. The function:

$$E ( x ) = {min}_{u ∈ L ( x )} Q ( x , u ) ,$$

is referred to as the evaluation function of nominal opponent engine 195 and provides a numerical assessment of any given position x, with castling, repetition detection, and other record-keeping features incorporated as part of the position data.

For some chess engines, the formula for E(x) is not strictly correct because certain legal moves at position x may be pruned, resulting in an approximation of the minimization that defines E(x). According to certain examples, MPC-MC framework 170 may be configured to assume that nominal opponent engine 195 is memoryless, meaning that Q(x,u) depends only on the current position-move pair (x,u) and not on any earlier game history or prior evaluations. In some configurations, chess engines utilized by MPC-MC framework 170 and executed as nominal opponent engine 195 are not strictly memoryless. For instance, certain engines may construct hash tables or transposition tables of evaluated positions that persist from one move to the next during a game. The architecture of MPC-MC framework 170 allows both memoryless and memory-persistent nominal opponent engines 195 to operate through chess engine integrator 175, enabling consistent evaluation and prediction even when such memory retention mechanisms are present.

In some configurations, memory persistence within nominal opponent engine 195 may influence the evaluation consistency of MPC-MC framework 170. When transposition tables or cached evaluation data are reused across successive positions, the predicted opponent response v(x,u) may be partially conditioned by prior search paths rather than computed independently. To mitigate bias resulting from such data reuse, chess engine integrator 175 may perform selective cache invalidation or weighting adjustment to ensure that predictions remain representative of fresh evaluations for each candidate move. Alternatively, distributed instances of nominal opponent engine 195 may operate with independent memory contexts to prevent cross-contamination of historical data between parallel evaluations. These mechanisms maintain statistical independence among simulated opponent responses and improve the stability of inference-based move prediction within MPC-MC framework 170.

To play against an opponent, MPC-MC framework 170 determines a move in response to a given position. To compute this move, MPC-MC framework 170 utilizes two engines: position evaluation engine 190, which produces a numerical evaluation of any given position, and nominal opponent engine 195, which serves as an exact replica or an approximation of the true opponent, whether another engine or a human player. In some examples, nominal opponent engine 195 may correspond to a chess engine such as Stockfish 295 (SK), Komodo Dragon 296 (KD), or Leela Chess Zero (LC0). Each such engine may be pre-existing and integrated into MPC-MC framework 170 via chess engine integrator 175. MPC-MC framework 170 deterministically generates movement output 178, which defines the move selected for play at a given position. Movement output 178 may be evaluated, adopted, or overridden by a human player utilizing MPC-MC framework 170 in an augmented intelligence mode, or alternatively provided as digital control data to a downstream system that executes gameplay automatically. In some configurations, movement output 178 may represent a discrete next move or a probability distribution of possible moves ranked according to predictive likelihood of achieving a favorable outcome such as a win.

In some examples, nominal opponent engine 195 may adapt dynamically based on observed discrepancies between predicted and actual opponent moves. MPC-MC framework 170 may record data from prior games or simulated sessions and adjust internal parameters, weighting functions, or selection probabilities associated with opponent modeling. These adaptive updates may occur between games or following a predetermined number of inference cycles. Reinforcement signals derived from evaluation differences may be used to refine the predictive model of nominal opponent engine 195, allowing it to better represent statistical patterns of opposing play and thereby enhance accuracy of subsequent inference-based move selection.

In the absence of knowledge of the true opponent, MPC-MC framework 170 may employ a competent chess engine as nominal opponent engine 195, such as the same engine utilized as position evaluation engine 190 for generating position evaluations 250. In some examples, however, nominal opponent engine 195 and position evaluation engine 190 may differ to enable diverse analytical perspectives. A relatively weak or poorly performing nominal opponent engine 195 is typically avoided, since its use could lead to underestimation of the true opponent's capabilities and degraded predictive accuracy. In certain implementations, nominal opponent engine 195 may be reconfigured or replaced between games to adapt dynamically to different opponent profiles. Knowledge elements associated with position evaluation engine 190 and nominal opponent engine 195, such as opening books or endgame tablebases, may be indirectly incorporated into MPC-MC framework 170 through chess engine integrator 175, providing additional contextual data for decision-making.

To mathematically describe movement output 178 of MPC-MC framework 170 at a position xₖ and connect it with optimal control formulations, the following notation is used. The term xₖ represents the chess position at time or move index k. The term uₖ denotes a legal move at time k in response to position xₖ. The term wₖ represents the move selected by nominal opponent engine 195 at time k in response to position xₖ following move uₖ. The resulting position at time k+1 is defined by the function:

$${x}_{k + 1} = f ( {x}_{k} , {u}_{k} , {w}_{k} ) ,$$

where f is a known transition function representing the dynamic system of the game. This formulation corresponds to a standard model predictive control structure in which xₖ is treated as the system state, uₖ as the control variable, and wₖ as a known or unknown (possibly stochastic) disturbance.

With reference again to FIG. 2, the operation of MPC-MC framework 170 with one-step lookahead proceeds through a defined sequence of calculations. First, MPC-MC framework 170 generates all legal moves uₖ for the current position xₖ within legal move set 220. Second, for each pair (xₖ, uₖ), nominal opponent engine 195 evaluates the position and generates a predicted opponent move denoted by the function v(xₖ, uₖ). Third, for each uₖ, position evaluation engine 190 evaluates the resulting position x₍ₖ₊₁₎=f(xₖ, uₖ, \tilde{w}ₖ), where \tilde{w}ₖ=v(xₖ, uₖ), to obtain a corresponding numerical evaluation value. Fourth, MPC-MC framework 170 compares the evaluation results for all legal moves and selects the move uₖ associated with the most favorable evaluation outcome. This process yields the preferred move, which is encoded as control data for movement output 178 to define the next move for gameplay execution.

MPC-MC framework 170 performs approximately twice as many computations as a single engine evaluation cycle, since each candidate move uₖ requires both a predicted opponent response generation and a position evaluation. Specifically, MPC-MC framework 170 executes roughly 2m computations per iteration, where m represents the number of legal moves in the current position xₖ. Despite this increased computational requirement, the architecture is well suited to parallelization, such that with sufficient computational resources, the total runtime may approach that of a single-engine evaluation. When position evaluation engine 190 and nominal opponent engine 195 internally use search parallelization, MPC-MC framework 170 inherits this efficiency and extends it further. At each stage of lookahead, multiple predicted opponent responses and corresponding position evaluations can be processed in parallel with near-full utilization, thereby maintaining responsiveness and throughput during move prediction and selection cycles.

### Deterministic and Stochastic Variants:

Two basic variants of MPC-MC framework 170 are described. The first, called deterministic, involves an exact prediction of the response from the true opponent, using this prediction as the move by nominal opponent engine 195. The deterministic variant can be regarded as a special case of a standard MPC-MC framework 170. The second variant, called stochastic, involves generating only an approximate prediction and serves as an approximation of the MPC-MC framework 170.

In the deterministic variant of MPC-MC framework 170, the move of the true opponent can be predicted precisely in response to a position xₖ and a legal move uₖ. This prediction is then used as the corresponding move by nominal opponent engine 195. Accordingly, nominal opponent engine 195 replicates the play behavior of the true opponent. In this case, if v(x, u) denotes the nominal opponent move in response to position x followed by move u, the resulting sequence of positions generated during actual gameplay evolves according to the relations defined below.

Equation 1 is set forth below, as follows:

$${x}_{k + 1} = F ( {x}_{k} , {u}_{k} ) ,$$

where, according to Equation 2, set forth below as follows:

$$F ( {x}_{k} , {u}_{k} ) = f ( {x}_{k} , {u}_{k} , v ( {x}_{k} , {u}_{k} ) ) .$$

In this deterministic configuration, v(xₖ, uₖ) represents the move generated identically by both nominal opponent engine 195 and the true opponent engine in response to position xₖ and the MPC-MC framework 170 move uₖ.

Equations 1 and 2 together model a chess game as the evolution of a deterministic controlled system, in which the chess position x represents the system state and the legal move u represents the control input. Regarding the cost function, a nonzero cost occurs only at terminal positions where one of the opponents wins the game. The optimal cost function J*(x) is the solution to the Bellman equation, which is the fundamental equation of exact dynamic programming (DP), expressed as follows:

$${J}^{*} ( x ) = {min}_{u ∈ L ( x )} {J}^{*} ( F ( x , u ) ) ,$$

Here, J*(x)≠0, for all positions x that result in a win for either player, regardless of the opponent's play, and J*(x)=0 for all other positions x that correspond to theoretical draws.

The optimal cost function J* is unknown at the starting chess position and for most other positions as well. Many grandmasters believe that the starting position s is a theoretical draw, such that J*(s)=0, based on the near-perfect play of top chess engines, which are virtually unbeatable by other engines and effectively unassailable by human players when the time limit per move is sufficiently long. Because of the astronomical state-space complexity of chess, the optimal cost function J*(x) is not expected to be computed in the foreseeable future.

In the approximation in value space approach of reinforcement learning (RL), which is similar to the technique applied by MPC-MC framework 170, the unknown function J* is approximated. Accordingly, MPC-MC framework 170 approximates J* by the evaluation function E of position evaluation engine 190. Specifically, at position x, MPC-MC framework 170 acting as one player selects the move defined by Equation 4, set forth below as follows:

$$\tilde{u} ∈ arg {min}_{u ∈ L ( x )} E ( F ( x , u ) ) ,$$

where the required values of F are computed using nominal opponent engine 195 (also the true opponent), and the values of E are calculated by position evaluation engine 190.

Notably, performance of MPC-MC framework 170 acting as a player surpasses the performance of position evaluation engine 190, provided that the play by position evaluation engine 190 is reasonably close to optimal. This conclusion follows from theoretical principles that extend beyond chess and explain the performance improvement observed in model predictive control (MPC) and reinforcement learning (RL) schemes based on approximation in value space. The optimal cost function J*(x) described herein corresponds to the Bellman equation of exact dynamic programming (DP), and the same principle underlies the Newton-type performance improvement property described in Equation (3).

Performance of MPC-MC framework 170 was experimentally demonstrated to exceed that of position evaluation engine 190 operating independently of MPC-MC framework 170. The improvement was generally significant, though it tended to diminish in absolute terms as position evaluation engine 190 approached optimality. This is because when position evaluation engine 190 achieves perfect or near-optimal play, no further performance improvement is possible. However, in relative terms, the performance gain of MPC-MC framework 170 acting as a player increases as position evaluation engine 190 approaches optimality. Specifically, the following relation defined by Equation (5) holds true:

$$\frac{{J}_{\tilde{μ}} ( x ) - {J}^{*} ( x )}{\tilde{J} ( x ) - {J}^{*} ( x )} \to 0 , as \tilde{J} \to {J}^{*} ,$$

where \tilde{μ} represents the move-selection policy of MPC-MC framework 170 acting as a player, where J_{\tilde{μ}}(x) denotes the performance of MPC-MC framework 170 starting from any position x, and where \tilde{J}(x) corresponds to the position evaluation 250 produced by position evaluation engine 190.

In some implementations, Equation (5) may be interpreted as describing a superlinear performance relationship within approximate value space, consistent with the convergence characteristics of Newton-type optimization applied to the Bellman equation. Under this interpretation, as the evaluation function E(x) of position evaluation engine 190 more closely approximates the optimal cost function J*(x), the relative error between J_{\tilde{μ}}(x) and J*(x) decreases at a rate faster than linear with respect to the error of \tilde{J}(x). This behavior reflects accelerated convergence of the predictive-control policy and indicates that MPC-MC framework 170 achieves progressively higher precision in move selection as position evaluation engine 190 approaches optimal play. Normalization of evaluation scales may be applied so that J*(x)=0 corresponds to a loss, J*(x)=1 corresponds to a win, and \tilde{J}(x) representing a probability of winning or an expected outcome from position x. This normalization ensures that J_{\tilde{μ}}(x) and \tilde{J}(x) are directly comparable with J*(x), allowing the superlinear performance relationship of Equation (5) to be expressed on a uniform comparative scale. The relation is characteristic of the Newton-type convergence behavior predicted by theory, and experimental results obtained for MPC-MC framework 170 have been consistent with this relationship.

The use of position evaluation engine 190 to approximate the optimal cost function is analogous to the rollout algorithm from dynamic programming (DP) and reinforcement learning (RL), in which the optimal cost function is approximated by the cost function of a base policy. In this case, the base policy corresponds to the move-selection policy of position evaluation engine 190, and its cost function is approximated by the corresponding engine evaluations.

In the stochastic variant of MPC-MC framework 170, the move of a true opponent cannot be predicted exactly in response to (xₖ, uₖ). Instead, the move generated by nominal opponent engine 195, which approximates the play of the true opponent, is used. If v(x, u) represents the nominal opponent move in response to position x followed by move u, then MPC-MC framework 170 calculates its move according to Equation (6), set forth below, as follows:

$$\tilde{u} ∈ arg {min}_{u ∈ L ( x )} E ( F ( x , u ) ) ,$$

where, according to Equation 7, set forth below, as follows:

$$F ( x , u ) = f ( x , u , v ( x , u ) ) .$$

However, the positions generated during an actual game may occasionally deviate from those generated by Equation (8), set forth below, as follows:

$${x}_{k + 1} = F ( {x}_{k} , {u}_{k} ) ,$$

since the play of the true opponent can deviate from the play of the nominal opponent.

While the performance improvement property described in Equation (5) cannot be formally established for the stochastic variant of MPC-MC framework 170 acting as a player, the improvement generally holds approximately, provided that the nominal opponent is a strong player. Experimental data indicate that nominal opponent engine 195 should perform at least as well as, and preferably better than, the true opponent. A potential explanation for this requirement is that MPC-MC framework 170 may select a poor or even catastrophic move uₖ if the nominal opponent generates an inadequate response v(xₖ, uₖ), leading to position x₍ₖ₊₁₎ that is favorably evaluated by position evaluation engine 190. Therefore, it is important that the nominal opponent does not underestimate the true opponent.

Although MPC-MC framework 170 performs well in computational experiments, occasional errors may occur even when very strong nominal opponent engine 195 and position evaluation engine 190 are employed. Such errors typically arise from the approximation of minimax play by the moves of nominal opponent engine 195. This type of issue is common in truncated rollout algorithms for approximate dynamic programming (DP) or reinforcement learning (RL), where the search guided by a base policy is extended to only a limited lookahead depth.

A useful supplement to truncated rollout algorithms is fortification, wherein the base policy is followed at states where the rollout policy appears ineffective. A fortified variant of MPC-MC framework 170 operates as follows. For a given position xₖ, once a move ũₖ is computed using the MPC-MC policy from Equation (4) or Equation (6), the policy is compared with the move suggested by the position evaluator at xₖ, denoted as u_{\hat{k}}. The fortified MPC-MC framework 170 then executes u_{\hat{k}} if its evaluation Q(xₖ, u_{\hat{k}}) is better than that of ũₖ; otherwise, ũₖ is played.

As suggested by the preceding discussion, the fortified MPC-MC framework 170 is conservative but provides safeguards against overambitious play by an unfortified configuration of the system.

Computational experiments demonstrate that fortification is effective against very strong opponents, such as Stockfish engine SK 295 operating as nominal opponent engine 195, which can exploit even minor inaccuracies made by MPC-MC framework 170.

Conversely, fortification may lead to a small reduction in performance when competing against weaker opponents, against whom MPC-MC framework 170 already possesses a decisive advantage.

Overall, the fortified MPC-MC variant provides a balanced trade-off between safety and aggressiveness, improving robustness without materially degrading performance under typical gameplay conditions.

COMPUTATIONAL RESULTS: MPC-MC framework 170 has also been tested with chess engines which rely exclusively on (off-line trained) transformer neural networks to provide position evaluations 250 without further search. At each current position and for every legal move, these engines calculate a Q-factor and select the move with the optimal Q-factor calculation 505 (see FIG. 5). These engines exhibit strong grandmaster-level performance against human opponents but generally perform below SK 295 and KD engines.

Nonetheless, in a limited set of experiments, MPC-MC framework 170 was shown to provide a marked performance improvement, consistent with outcomes observed with SK 295 and KD engines. In these experiments, these engines were used for only part of each game. Specifically, the first 12 moves of each game were generated using SK 295 (playing against itself) to reach a variety of middlegame positions from which MPC-MC framework 170 use could commence. As the transformer engines are not well suited for handling endgames, SK 295 was substituted when the number of pieces reached 12 or fewer. These transformers have structures similar to those of versatile large language models, which are applicable across a range of fields. This suggests potential compatibility of offline-trained transformers with MPC-MC framework 170 across diverse minimax sequential decision-making environments, including two-person zero-sum games beyond chess.

In certain examples, transformer-based position evaluators may be fine-tuned using domain-specific datasets to extend MPC-MC framework 170 beyond chess applications. For instance, predictive models trained on sequential decision processes from other domains, such as economic simulations, robotic control, or strategic resource allocation, may serve as analogues to position evaluation engine 190 and nominal opponent engine 195. Each model may encode a learned approximation of an optimal value function J*(x) and policy μ(x), allowing MPC-MC framework 170 to generalize the predictive-control approach to any two-agent or adversarial system that can be represented as a dynamic transition function f(x, u, w). Transformer architectures are particularly advantageous in these contexts due to their ability to model long-range dependencies and context-conditioned transitions, enabling efficient approximation of evaluation functions and opponent-response mappings even in high-dimensional decision spaces.

MPC-MC Framework with Stockfish and Komodo Dragon Chess Engines: The following computational details describe operation of MPC-MC framework 170 with one-step lookahead when specialized chess engines, including Stockfish 295 (SK 295) and the freely available version of Komodo Dragon (KD 296), are used as nominal opponent engine 195 and/or position evaluation engine 190. Using the procedures of MPC-MC framework 170 discussed above, these engines can be integrated within the framework to enable both self-play and competitive evaluations.

Computational studies were conducted to examine the deterministic and stochastic variants of MPC-MC framework 170 and to evaluate the effect of fortification on gameplay performance. Experimental implementations of MPC-MC framework 170 were executed using multiple combinations of chess engines and configuration settings to validate predictive-control performance. Observed results confirmed consistent improvement in evaluation precision and decision efficiency relative to baseline search engines operating independently. Although quantitative results vary depending on engine strength and available computation time, all empirical tests demonstrated reproducible gains consistent with theoretical performance relations described herein.

Given a chess position xₖ at time k and a legal move uₖ, both SK 295 and KD 296 engines select a move v(xₖ, uₖ) using their internal decision functions. Each engine may also be used to provide scalar position evaluations E(x₍ₖ₊₁₎) for any resulting chess position x₍ₖ₊₁₎. Both movement output 178 and position evaluation 250 generated by position evaluation engine 190 may depend on various configuration parameters. For experimental consistency, the only variable adjusted was the computational time limit assigned to each engine, which directly influenced relative strength. When two nominal opponent engines 195 of the same type (either SK 295 or KD 296) were tested, the engine allocated a longer time limit was treated as the stronger player.

Both deterministic and stochastic variants of MPC-MC framework 170 were evaluated using time limits of 0.5, 2, and 5 seconds. At a 5-second limit, KD 296 plays at very high strength, while SK 295 achieves near-optimal performance. To eliminate the effect of cached data, all tests employed engines without stored hash tables.

In the deterministic variant of MPC-MC framework 170, the rollout-selected moves generated by the nominal opponent were executed directly in actual gameplay. In contrast, in the stochastic variant, the true opponent's moves were chosen by an independent engine of equivalent nominal strength to engine 195. Even when identical configurations and no hash data were used, the engines occasionally selected different moves for the same pair (xₖ, uₖ) due to internal stochastic processes and evaluation nondeterminism. Consequently, the nominal opponent's predicted moves could differ from those of the true opponent, resulting in stochastic movement output 178 by MPC-MC framework 170. To maintain fairness, the computational resources of the true opponent were restricted to match those used for evaluating a single legal move within MPC-MC framework 170.

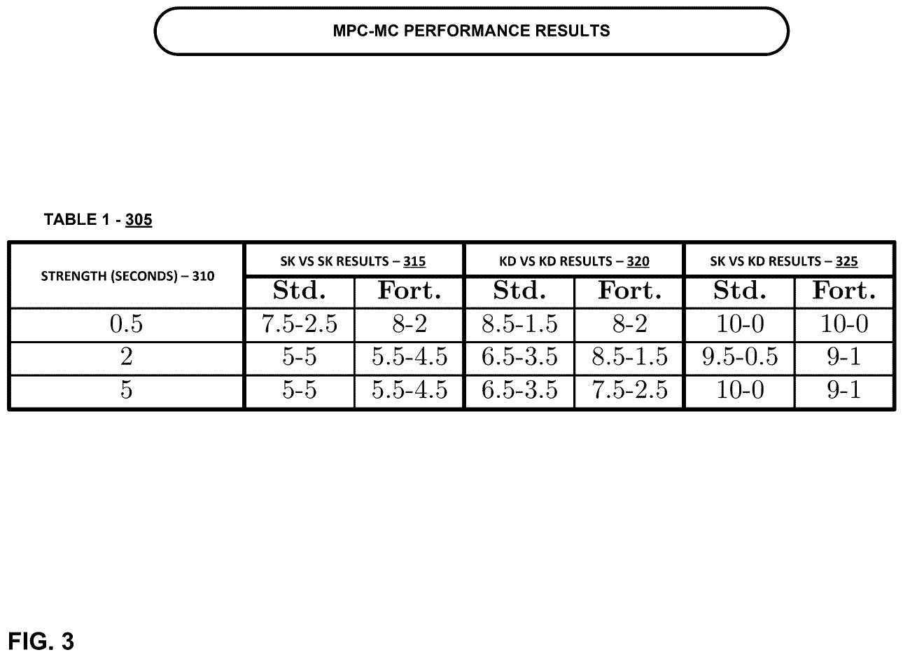

FIG. 3 depicts Table 1 (305) providing test results for deterministic model predictive control-meta chess (MPC-MC) framework 170, in accordance with aspects of this disclosure. Table 1 (305) summarizes comparative performance outcomes for deterministic MPC-MC framework 170 executed with multiple chess-engine configurations.

Each experiment listed within Table 1 305 was performed under controlled computational conditions consistent with the architecture of computing device 100 shown in FIG. 1, using equivalent processing circuitry, memory, and power constraints to ensure consistent evaluation. Strength 310 corresponds to computation time, expressed in seconds, allocated per move to each engine during testing.

The first column group identified as “SK vs SK results” 315 presents outcomes in which Stockfish 295 (SK 295) served simultaneously as nominal opponent engine 195, position evaluation engine 190, and true opponent. The second column group identified as “KD vs KD results” 320 lists results where Komodo Dragon 296 (KD 296) filled those same roles. The third column group identified as “SK vs KD results” 325 presents mixed-engine play, in which SK 295 served as position evaluation engine 190 while KD 296 operated as both nominal opponent engine 195 and true opponent.

Within each engine pairing, MPC-MC framework 170 was evaluated in two configurations designated “Std.” (standard) and “Fort.” (fortified). In the fortified configuration, the control policy of MPC-MC framework 170 executed a supplemental comparison between its predicted move and a base-policy move generated by position evaluation engine 190, selecting whichever yielded a superior numerical evaluation value.

Scores shown in Table 1 305 represent cumulative match outcomes over multiple games, expressed in standard chess-tournament notation, where a win, draw, and loss contribute 1, 0.5, and 0 points respectively. Higher totals indicate stronger relative performance of MPC-MC framework 170 under the corresponding configuration.

Across all test conditions, deterministic MPC-MC framework 170 remained undefeated. Performance improvements were most pronounced at shorter computation-time limits, indicating that MPC-MC framework 170 effectively compensates for reduced search depth by integrating predictive control and reinforcement-based evaluation. At longer computation times (e.g., 5 seconds), differences between standard and fortified variants narrowed, reflecting convergence toward near-optimal engine play.

Results for “SK vs KD results” 325 confirm the relative strength of SK 295 over KD 296 under identical time constraints, while also demonstrating that MPC-MC framework 170 incorporating fortification maintained consistent superiority. Collectively, the data in Table 1 305 validate that deterministic MPC-MC framework 170 yields quantifiable performance enhancement when coupled with existing chess engines without requiring modification of their internal evaluation logic.

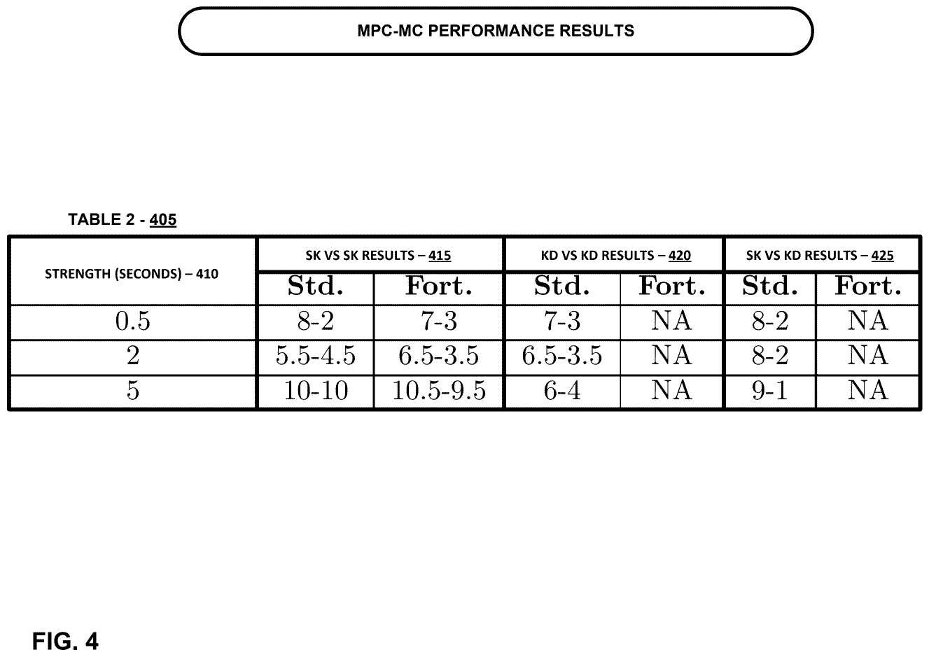

FIG. 4 depicts Table 2 (405) providing test results for stochastic model predictive control-meta chess (MPC-MC) framework 170, in accordance with aspects of this disclosure. Table 2 (405) summarizes comparative performance outcomes for stochastic MPC-MC framework 170 executed with identical chess-engine configurations under controlled computational conditions. Strength (410) denotes the computation time per move, expressed in seconds, allocated to each engine during testing.

The first column group identified as “SK vs SK results” 415 presents outcomes in which Stockfish 295 (SK 295) served simultaneously as nominal opponent engine 195, position evaluation engine 190, and true opponent. The second column group identified as “KD vs KD results” 420 lists results in which Komodo Dragon 296 (KD 296) fulfilled those same roles. The third column group identified as “SK vs KD results” 425 presents mixed-engine play, with SK 295 functioning as position evaluation engine 190 and KD 296 serving as both nominal opponent engine 195 and true opponent.

Each experiment in Table 2 405 was conducted using computing device 100 of FIG. 1, configured with equivalent processing circuitry, memory, and power parameters to ensure consistent evaluation across all stochastic-variant tests. Both nominal opponent engine 195 and true opponent engine were executed at equal computational strength; however, because the engines operate independently, nondeterministic variations in internal evaluation and move ordering caused divergence in selected moves for otherwise identical positions. This behavior produced the stochastic conditions under which MPC-MC framework 170 was evaluated.

The column entries are labeled “Std.” (standard) and “Fort.” (fortified) indicate the respective MPC-MC framework 170 configurations applied in each test case. Fortified testing was completed only for “SK vs SK results” 415, as the performance margin for MPC-MC framework 170 in “KD vs KD results” 420 and “SK vs KD results” 425 was already decisive under standard configuration. In the fortified configuration, MPC-MC framework 170 compared its rollout-selected move with the base-policy move of position evaluation engine 190 and adopted whichever yielded a superior numerical evaluation value.

Scores reported in Table 2 405 represent cumulative match outcomes across multiple games, expressed in standard chess-tournament notation, where a win, draw, and loss contribute 1, 0.5, and 0 points respectively. As observed with deterministic results in Table 1 305, stochastic MPC-MC framework 170 achieved no losses across any tested configuration. Numerical outcomes closely align with those recorded for deterministic MPC-MC framework 170, demonstrating that predictive-control-based move selection retains robustness even when the nominal opponent's behavior deviates from the true opponent's actions.

Performance data in “SK vs KD results” 425 confirm the continued advantage of SK 295 over KD 296 across all time-control conditions. Comparative analysis indicates that stochastic MPC-MC framework 170 maintains the same superlinear improvement characteristics described for deterministic MPC-MC framework 170, validating its capacity to enhance decision quality without requiring deterministic opponent modeling. Collectively, the results in Table 2 405 confirm that stochastic MPC-MC framework 170 provides consistent performance gains relative to baseline engines while maintaining computational efficiency comparable to that of deterministic testing.

FIG. 5 depicts a schematic illustration of model predictive control-meta chess (MPC-MC) framework 170 with half-step lookahead, in accordance with aspects of this disclosure. MPC-MC framework 170 with half-step lookahead represents a simplified configuration in which nominal opponent engine 195 shown in FIG. 2 is omitted. In this configuration, position evaluation engine 590 performs all move-evaluation functions from the perspective of both players, using position-scoring data generated by integrated chess engines such as Stockfish 595.

Position evaluation engine 590 receives digital state data representing a current game position and generates legal move set 591 defining all available legal moves for that position. Each legal move within legal move set 591 corresponds to a candidate control variable considered by MPC-MC framework 170. Move selector 260 processes digital representations of all legal moves and outputs each candidate position to Stockfish 595 for numerical scoring.

Each instance of Stockfish 595 evaluates a position corresponding to a candidate move and outputs a numerical value indicating the strength or weakness of that position from the opponent's perspective. These evaluations are processed as position evaluation from opponent perspective 598. Q-factor calculation 505 computes a quality metric, or Q-factor, representing the relative difficulty or disadvantage imposed on the opponent by each candidate move. The Q-factor reflects the numerical evaluation difference between the player's and the opponent's projected perspectives for the same position.

MPC-MC framework 170 selects the move associated with the smallest opponent-advantage value or, equivalently, the move that maximizes the predicted disadvantage to the opponent as quantified by Q-factor calculation 505. Move selector 260 therefore identifies the legal move from legal move set 591 that minimizes the evaluation result of position evaluation from opponent perspective 598 and designates that move as the preferred move for gameplay execution.

Functionally, MPC-MC framework 170 with half-step lookahead retains the mathematical interpretation of a Newton-method iteration but without the stabilizing effect provided by nominal opponent engine 195. The absence of nominal opponent engine 195 introduces reduced reliability, since the concavity assumptions underlying the Bellman operator in the full MPC-MC formulation are not strictly satisfied. Nevertheless, the half-step configuration provides valuable computational efficiency by eliminating one evaluation layer and reducing total computation approximately by half relative to the one-step lookahead structure illustrated in FIG. 2.

When implemented in software, position evaluation engine 590 may execute within computing device 100 described in FIG. 1, using processing circuitry 102, memory 104, and storage 108 to store evaluation parameters and engine configurations. Each Stockfish 595 instance may operate as a subprocess or thread within position evaluation engine 590, allowing parallel computation of numerical evaluations for all moves in legal move set 591. The resulting architecture enables near real-time inference-based move selection for complex positions while maintaining compatibility with other chess engines or evaluation modules that can be integrated through chess engine integrator 175 of FIG. 2.

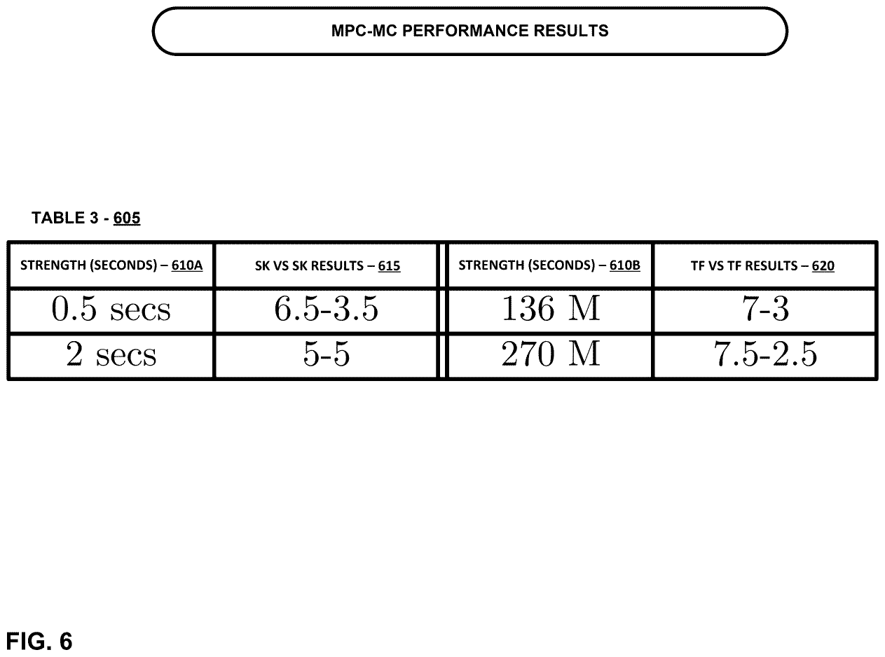

FIG. 6 depicts Table 3 (605), providing test results for stochastic model predictive control-meta chess (MPC-MC) framework 170, in accordance with aspects of this disclosure. Each experiment summarized in Table 3 (605) was executed using computing device 100 described in FIG. 1, configured with equivalent processing circuitry (102), memory (104), storage (108), and network interface (106) to ensure consistent evaluation conditions across test cases.

The left portion of Table 3 605 presents results for stochastic MPC-MC framework 170 operating with Stockfish 295 (SK 295) serving as position evaluation engine 590 and nominal opponent engine 195. The column designated “SK vs SK results 615” reports self-play match outcomes under two configurations determined by computation time per move. The corresponding “strength (seconds) 610A” column specifies the time allocated to each engine. When configured at 0.5 seconds per move, MPC-MC framework 170 achieved a 6.5-3.5 score across ten games. With 2 seconds per move, performance equilibrated at 5-5, indicating parity between the MPC-MC-controlled instance and the baseline SK 295 engine.

The right portion of Table 3 605 summarizes tests executed with transformer-based neural network engines applied to position evaluation, Q-factor estimation, and policy guidance. The associated “strength (parameters) 610B” column denotes the model scale in millions of trainable parameters. The column labeled “TF vs TF results 620” lists performance outcomes for transformer-based engines operating within MPC-MC framework 170. With a 136-million-parameter configuration, MPC-MC framework 170 recorded a 7-3 result over ten games, while the 270-million-parameter configuration achieved 7.5-2.5, demonstrating measurable improvement with increased model capacity.

Collectively, the data in Table 3 605 validate that stochastic MPC-MC framework 170 provides consistent performance benefits across both classical search-based and transformer-based architectures. Although the half-step lookahead variant of MPC-MC framework 170 yields marginally lower aggregate scores than the one-step configuration shown in FIGS. 2-4, it continues to outperform baseline engines operating independently. Computationally, the half-step variant functions as a single Newton-method iteration applied to the Bellman equation of the underlying minimax control formulation, producing improved convergence characteristics while reducing total evaluation cost by approximately fifty percent relative to the one-step configuration.

FIG. 7 depicts a schematic illustration of model predictive control-meta chess (MPC-MC) framework 170 with two-step lookahead and a deterministic nominal opponent, in accordance with aspects of this disclosure. The configuration shown in FIG. 7 expands the one-step structure of FIG. 2 to evaluate two successive prediction horizons in advance of gameplay execution. In the illustrated example, current position 710 represents digital state data corresponding to the board configuration at a discrete time step k, denoted xₖ. Move selector 760 identifies a candidate move uₖ from legal move set 720 that defines all legal actions available from current position 710. Each candidate move uₖ is processed to determine a corresponding nominal opponent response generated by nominal opponent engine 795.

Nominal opponent engine 795 may execute one or more chess engines, such as Stockfish 797, configured to simulate the decision-making behavior of an opponent player. For each move uₖ in legal move set 720, nominal opponent engine 795 outputs a predicted response wₖ and produces a resulting next position x₍ₖ₊₁₎. The transition from xₖ to x₍ₖ₊₁₎ is defined by the dynamic function:

$${x}_{k + 1} = f ( {x}_{k} , {u}_{k} , {w}_{k} ) .$$

For each next position x₍ₖ₊₁₎, move selector 760 again generates all legal moves u₍ₖ₊₁₎ within all legal moves 791, each of which represents a second-level control variable under consideration. Nominal opponent engine 795 again predicts an optimal response w₍ₖ₊₁₎ for each candidate move u₍ₖ₊₁₎, producing a subsequent position x₍ₖ₊₂₎ according to the relation:

$${x}_{k + 2} = f ( {x}_{k + 1} , {u}_{k + 1} , {w}_{k + 1} ) .$$

Position evaluation engine 790 evaluates every resulting position x₍ₖ₊₂₎ to generate corresponding numerical evaluation values 740 that quantify the relative advantage or disadvantage associated with each potential move sequence. Each numerical evaluation value 740 may represent a scalar position score, probability of win, or expected value derived from heuristic evaluation functions implemented by Stockfish 797 or another engine coupled through position evaluation engine 790.

The evaluation process proceeds as follows. For each first-level move uₖ, MPC-MC framework 170 aggregates the evaluation results of all second-level move sequences (u₍ₖ₊₁₎), w₍ₖ₊₁₎) that follow from uₖ. Position evaluation engine 790 computes an overall value associated with the best second-level outcome reachable from uₖ. Move selector 760 compares these aggregated evaluation results for all first-level moves uₖ and selects the move producing the most favorable evaluation outcome as the preferred move for execution. The two-step lookahead policy implemented by MPC-MC framework 170 performs a nested optimization of the form:

$${\tilde{u}}_{k} ∈ arg {min}_{( u k} ∈ L ( {x}_{k} ) ) {min}_{( u ( k + 1 )} ∈ L ( F ( {x}_{k} , uk ) ) , E ( F ( F ( {x}_{k} , uk ) , u ( k + 1 ) ) ) ,$$

where E(·) denotes the evaluation function provided by position evaluation engine 790, and F(·) represents the dynamic transition operator defined by nominal opponent engine 795.

The computational complexity of this two-step configuration scales quadratically with the number of legal moves m available at the current position. Specifically, the total number of position evaluations is approximately m², and the total number of nominal opponent move generations is m²+m. While this substantially increases computation relative to the one-step configuration of FIG. 2, the structure of MPC-MC framework 170 supports parallelization across processing threads or distributed computing nodes, allowing the two-step evaluation to be completed within practical time constraints.

To enhance efficiency, pruning methods may be applied after the first nominal opponent stage. In one implementation, position evaluation engine 790 evaluates each intermediate position x₍ₖ₊₁₎ resulting from predicted opponent moves wₖ and removes from further consideration any positions with relatively poor evaluation values. The remaining subset of positions x₍ₖ₊₁₎ forms a reduced search horizon for the second-level lookahead, thereby concentrating computational resources on the most promising continuations. In the example illustrated in FIG. 7, this pruning mechanism is shown as a narrowing of the branches leading to all legal moves 791 after the first-level evaluation by Stockfish 797.

In additional implementations, pruning within the two-step lookahead configuration may be dynamically adjusted according to a target computation budget or real-time latency constraint. Chess engine integrator 175 may determine an adaptive pruning threshold based on the distribution of intermediate evaluation scores, retaining only positions whose evaluations fall within a defined percentile range of the highest-ranked outcomes. The pruning ratio may be further modulated in response to processing load, available parallel threads, or time-per-move parameters communicated by MPC-MC framework 170. When executed on distributed systems, position evaluation engine 790 may coordinate pruning control among multiple nodes to balance workload and maintain consistent horizon depth across evaluation partitions. This adaptive pruning control enables predictable runtime performance while preserving near-optimal accuracy in two-step lookahead prediction.

The two-step lookahead process illustrated in FIG. 7 conforms to the general principles of model predictive control (MPC). According to MPC theory, accurate computation of the first-level minimization, corresponding to the selection of the immediate next move uₖ, is of primary importance, whereas perfect accuracy at deeper horizons contributes diminishing incremental benefit. Consequently, approximate evaluation or selective pruning at the second-level lookahead (e.g., the computation of x₍ₖ₊₂₎ positions) does not materially degrade overall performance provided that the first-level optimization is solved with sufficient precision.

In operation, the configuration of FIG. 7 allows MPC-MC framework 170 to balance computational depth against time constraints while retaining deterministic control over nominal opponent behavior. The resulting architecture enables enhanced strategic foresight and move-selection accuracy compared to the one-step variant of FIG. 2 and the half-step configuration of FIG. 5, while remaining computationally tractable through selective pruning and parallel evaluation of position trees.

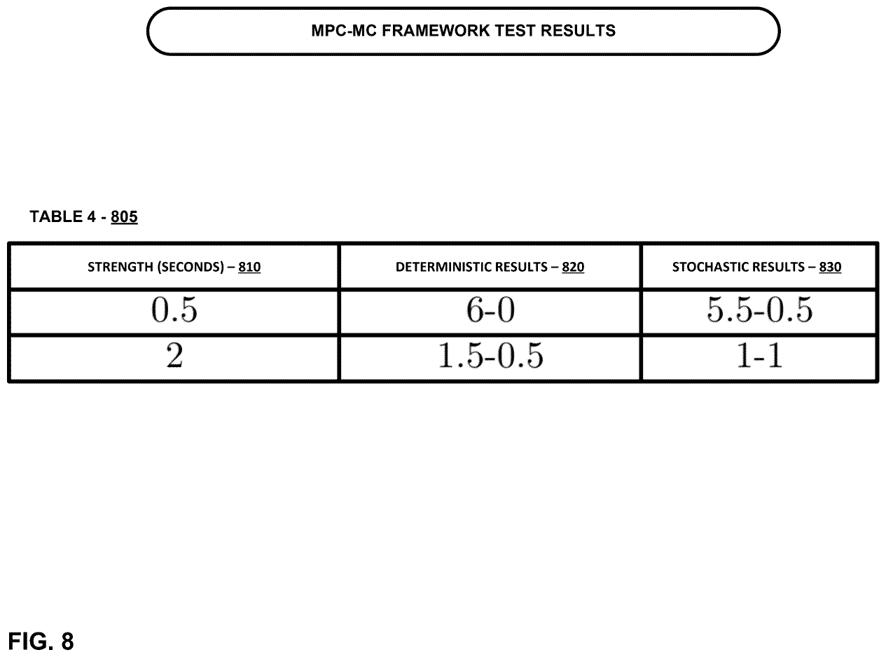

FIG. 8 depicts Table 4 (805), providing test results for model predictive control-meta chess (MPC-MC) framework 170 with two-step lookahead, in accordance with aspects of this disclosure. Table 4 (805) includes strength (seconds) (810), deterministic results (820), and stochastic results (830). Each entry corresponds to cumulative match outcomes recorded for Stockfish 295 (SK 295) engines operating within MPC-MC framework 170 under two-step lookahead configuration, as illustrated schematically in FIG. 7.

Experiments summarized in Table 4 805 were conducted using computing device 100 of FIG. 1, configured with equivalent processing circuitry 102, memory 104, storage 108, and network interface 106 to maintain consistent evaluation conditions. Each test measured the relative performance of deterministic and stochastic MPC-MC framework 170 variants against identical opponent configurations at predefined computational strengths expressed in seconds per move, as indicated by strength (seconds) 810.

At a strength of 0.5 seconds, deterministic results 820 for MPC-MC framework 170 yielded a 6-0 record, indicating six wins and no losses, while stochastic results 830 achieved 5.5-0.5, corresponding to five wins, one draw, and no losses. When engine computation time was increased to 2 seconds per move, deterministic results 820 produced 1.5-0.5, while stochastic results 830 recorded 1-1, representing balanced outcomes between MPC-MC-controlled and baseline engines. These data confirm that extending the prediction horizon to two steps enhances performance consistency and resilience to stochastic variation relative to one-step configurations shown in FIGS. 2 and 4.

The performance improvements observed in Table 4 805 align with theoretical predictions of model predictive control (MPC) and reinforcement learning (RL) formulations employing approximation in value space. The two-step configuration of MPC-MC framework 170 applies iterative optimization governed by the Newton method to approximate the Bellman equation associated with the underlying dynamic programming (DP) formulation. The results therefore provide experimental validation that the Newton-method-based MPC-MC framework 170 yields superlinear improvement in decision quality relative to the base evaluation function E(x) of position evaluation engine 190.

As with prior deterministic and stochastic variants, the magnitude of improvement depends upon the predictive fidelity of nominal opponent engine 195 and the proximity of position evaluation engine 190 to optimal play. When these components are both highly accurate, further improvement margins narrow, whereas in sub-optimal evaluation regimes, MPC-MC framework 170 provides significant relative gains. The observed 6-0 and 5.5-0.5 outcomes at 0.5 seconds confirm that predictive-control-driven inference compensates for truncated search depth and maintains dominance even under severe time constraints.

Because the two-step configuration increases total computation approximately three-fold relative to baseline engine execution, practical implementation relies on parallelization. Each nominal-opponent response and position evaluation may be processed concurrently using distributed computing resources, yielding near-linear scaling efficiency. Empirical timing measurements confirmed that two-step lookahead executed on multi-core and cloud-based hardware achieved throughput consistent with theoretical projections, validating the framework's scalability for real-time applications.

In some configurations, distributed instances of MPC-MC framework 170 may execute on heterogeneous computing environments including combinations of CPUs, GPUs, and tensor-processing units (TPUs). Each instance may perform partial evaluation or prediction for a subset of legal moves, with synchronization achieved through a shared control queue managed by chess engine integrator 175. The control queue may implement priority-based scheduling to ensure that higher-value move sequences, as determined by preliminary evaluations from position evaluation engine 790, are expanded first. To maintain deterministic reproducibility of move outcomes, synchronization may employ timestamped state identifiers and fixed random seeds for stochastic elements within nominal opponent engine 795. When deployed across multiple physical nodes, data exchange among distributed processes may utilize network interface 106 to transmit digital state data, evaluation results, and control updates, thereby preserving coherent operation across all computing units participating in the multi-node evaluation process.

The structure demonstrated in Table 4 805 further generalizes to other two-player zero-sum games with definable transition functions f(x,u,w) and evaluation mappings E(x). By substituting game-specific engines within nominal opponent engine 195 and position evaluation engine 190, the same predictive-control principles apply to domains such as Shogi, Go, and Reversi. The key architectural feature enabling this generalization is the representation of an adversarial environment as a deterministic or stochastic disturbance modeled by nominal opponent engine 195, transforming a two-player interaction into a single-agent predictive-control problem.

Beyond discrete games, the MPC-MC framework 170 may also be extended to continuous or hybrid decision environments involving physical or simulated control systems. In such implementations, state variables x may represent measurable system parameters, control variables u may represent actuation or input signals, and opponent responses w may represent environmental disturbances or adversarial actions. The same predictive-control formulation may therefore be applied to domains such as robotic manipulation, autonomous navigation, energy grid optimization, or economic market modeling. Position evaluation engine 190 may correspond to a predictive model trained to estimate a scalar performance index, while nominal opponent engine 195 may generate adversarial or uncertainty-based perturbations. The resulting configuration allows the MPC-MC framework 170 to serve as a unified predictive-control architecture adaptable to both discrete turn-based environments and continuous dynamic systems.

Accordingly, Table 4 805 and FIG. 8 collectively demonstrate that MPC-MC framework 170 with two-step lookahead integrates deterministic control, stochastic modeling, and reinforcement-based optimization to achieve superior strategic performance within computationally tractable limits. The quantitative results presented for strength (seconds) 810, deterministic results 820, and stochastic results 830 confirm that the architecture described with respect to FIG. 7 provides both theoretical and empirical advantages in predictive-inference-based move selection.

Implementations described herein are illustrative and not limiting. Features and configurations shown in association with specific examples may be combined or modified in other implementations without departing from the scope of the claims. Variations may include substitution of hardware components, adjustment of control algorithms, or application of MPC-MC framework 170 to predictive-control tasks beyond game-playing environments, including robotics, simulation, and other sequential decision-making domains. References to particular engines or evaluation models are exemplary and provided for clarity of exposition rather than limitation of scope.

The structures and techniques described for MPC-MC framework 170 may be realized as a system, apparatus, or computer-readable medium comprising executable instructions stored on non-transitory storage media. When executed by processing circuitry, such instructions may cause the processing circuitry to perform distributed or parallelized prediction, evaluation, and control selection as described herein. The system may include multiple processing nodes each configured to execute nominal opponent engine 195 and position evaluation engine 190 instances in coordination with chess engine integrator 175. Results of partial evaluations may be aggregated through network interface 106 to produce a unified control decision represented by control data defining a next action or move. The same system architecture may be applied to predictive-control tasks in domains including games, robotics, and dynamic simulation environments, where a modeled disturbance or opposing policy replaces the role of an adversarial player. This paragraph provides explicit support for the computer-readable-medium and system claim forms describing distributed, heterogeneous, and parallelized implementations of MPC-MC framework 170.

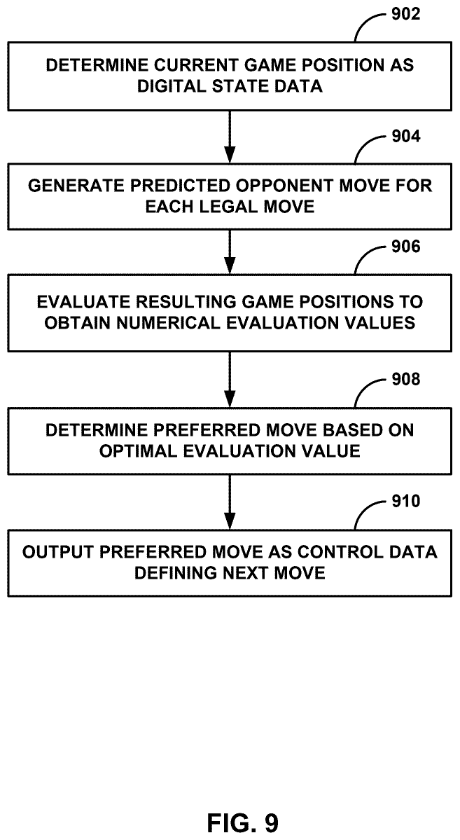

FIG. 9 is a flow diagram illustrating an example method for performing inference-based move selection in a game-playing system, in accordance with aspects of this disclosure. FIG. 9 is described with respect to computing device 100 of FIG. 1, including processing circuitry 102, position evaluation engine 190, nominal opponent engine 195, and move selector 160. However, the techniques of FIG. 9 may be performed by different components of computing device 100 or by additional or alternative systems configured for predictive-control-based gameplay and inference-driven decision optimization.

Processing circuitry of computing device 100 may be configured to determine current game position as digital state data (902). For example, processing circuitry 102 may determine a current game position within a game-playing environment and represent that position as digital state data defining the arrangement of all game elements at a discrete time step.

Processing circuitry of computing device 100 may be configured to generate predicted opponent moves for each legal move (904). For example, nominal opponent engine 195 may generate, for each legal move available from the current game position, a predicted opponent move responsive to that legal move, the nominal opponent engine 195 being configured to receive the digital state data and to output a move predicted to be selected by an opponent.

Processing circuitry of computing device 100 may be configured to evaluate resulting game positions to obtain numerical evaluation values (906). For example, position evaluation engine 190 may evaluate each subsequent game position that results from a predicted opponent move to obtain corresponding numerical evaluation values indicating relative advantage or likelihood of success associated with each evaluated position.

Processing circuitry of computing device 100 may be configured to determine preferred move based on optimal evaluation value (908). For example, move selector 160 may determine, based on the numerical evaluation values, a preferred move associated with an optimal evaluation value representing the most favorable predicted outcome.

Processing circuitry of computing device 100 may be configured to output preferred move as control data defining next move (910). For example, processing circuitry 102 may output the preferred move as control data that defines the next move to be executed within the game-playing environment or provided as digital control output to a downstream system implementing automated gameplay.

In this way, FIG. 9 illustrates a method for inference-based move selection using predictive control within a game-playing system, in which digital state data representing a current position is processed through a nominal opponent engine and position evaluation engine to determine an optimal move. The method enables adaptive, reinforcement-inspired decision-making that improves strategic accuracy and computational efficiency relative to conventional single-engine evaluation techniques.

This disclosure includes the following examples.

Example 1—A method for performing inference-based move selection in a game-playing system executed by one or more computing devices, the method comprising: determining, by processing circuitry of the one or more computing devices, a current game position that the processing circuitry represents as digital state data; generating, for each legal move from the current game position, a predicted opponent move responsive to the legal move using a nominal opponent engine configured to receive the digital state data and to output a move predicted to be selected by an opponent; evaluating, by a position evaluator engine executed by the processing circuitry, each subsequent game position that results from the predicted opponent move to obtain corresponding numerical evaluation values; determining, based on the numerical evaluation values, a preferred move associated with an optimal evaluation value; and outputting, by the processing circuitry, the preferred move as control data defining a next move to be executed in the game.

Example 2—The method of example 1, wherein the processing circuitry executes a model predictive control procedure that iteratively determines the preferred move over a finite prediction horizon.

Example 3—The method of example 1, wherein the nominal opponent engine generates the predicted opponent move using a deterministic policy corresponding to a predefined opponent configuration.

Example 4—The method of example 1, wherein the nominal opponent engine generates the predicted opponent move using a stochastic policy that outputs a probability distribution of potential opponent moves and selects a representative move from the distribution.

Example 5—The method of example 1, further comprising applying a fortified inference procedure that compares the preferred move with a base policy move generated by the position evaluator engine and selects the base policy move when its evaluation value is greater.

Example 6—The method of example 1, wherein evaluating each subsequent game position further comprises applying a rollout operation that extends simulated play through multiple future positions to refine the numerical evaluation values.

Example 7—The method of example 1, wherein determining the preferred move comprises identifying a move associated with a minimum cost-to-go estimate determined from the numerical evaluation values.

Example 8—The method of example 1, wherein the processing circuitry executes the nominal opponent engine and the position evaluator engine in parallel to reduce inference latency.

Example 9—The method of example 1, wherein the nominal opponent engine and the position evaluator engine are implemented as neural-network models trained through reinforcement learning prior to the inference-based move selection.

Example 10—The method of example 1, further comprising executing a multistep lookahead process that repeats the generating, evaluating, and determining steps for a defined lookahead depth greater than one.

Example 11—The method of example 1, further comprising analyzing prior opponent behavior from previous games and adapting configuration parameters of the nominal opponent engine in response to the analyzed behavior.

Example 12—The method of example 1, wherein the game-playing system performs inference for a two-person zero-sum game selected from the group consisting of chess, Shogi, Xiangqi, Go, Checkers, and Reversi.

Example 13—The method of example 1, wherein evaluating each subsequent game position comprises performing numerical evaluations for multiple legal moves using distributed processing resources.

Example 14—The method of example 1, further comprising monitoring elapsed inference time and adjusting weighting parameters applied to the numerical evaluation values to manage computational resources and inference latency.

Example 15—The method of example 1, wherein outputting the preferred move as control data comprises transmitting digital command data to a game interface that updates a displayed game state or controls a physical game actuator.

Example 16—The method of example 1, wherein determining the preferred move comprises applying a weighting factor to combine multiple numerical evaluation values respectively generated by a plurality of position evaluator engines, the weighting factor defining a composite evaluation value used to select the preferred move.

Example 17-A system comprising: processing circuitry; non-transitory computer-readable storage media; and instructions that, when executed by the processing circuitry, configure the processing circuitry to: determine a current game position that the processing circuitry represents as digital state data; generate, for each legal move from the current game position, a predicted opponent move responsive to the legal move using a nominal opponent engine configured to receive the digital state data and to output a move predicted to be selected by an opponent; evaluate, using a position evaluator engine executed by the processing circuitry, each subsequent game position that results from the predicted opponent move to obtain corresponding numerical evaluation values; determine, based on the numerical evaluation values, a preferred move associated with an optimal evaluation value; and output, by the processing circuitry, the preferred move as control data defining a next move to be executed in the game.

Example 18—The system of example 17, wherein the processing circuitry executes a model predictive control procedure that iteratively determines the preferred move over a finite prediction horizon.

Example 19—The system of example 17, wherein the processing circuitry executes the nominal opponent engine and the position evaluator engine in parallel to reduce inference latency.

Example 20—Non-transitory computer-readable storage media comprising instructions that, when executed by processing circuitry, cause the processing circuitry to: determine a current game position that the processing circuitry represents as digital state data; generate, for each legal move from the current game position, a predicted opponent move responsive to the legal move using a nominal opponent engine configured to receive the digital state data and to output a move predicted to be selected by an opponent; evaluate, using a position evaluator engine executed by the processing circuitry, each subsequent game position that results from the predicted opponent move to obtain corresponding numerical evaluation values; determine, based on the numerical evaluation values, a preferred move associated with an optimal evaluation value; and output, by the processing circuitry, the preferred move as control data defining a next move to be executed in the game.

Example 21—A computer program product comprising one or more instructions that, when executed by at least one processor, cause the at least one processor to perform any of the methods of examples 1-16.

Example 22—A device comprising means for performing any of the methods of examples 1-16.

For processes, apparatuses, and other examples or illustrations described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

In accordance with the examples of this disclosure, the term “or” may be interrupted as “and/or” where context does not dictate otherwise. Additionally, while phrases such as “one or more” or “at least one” or the like may have been used in some instances but not others; those instances where such language was not used may be interpreted to have such a meaning implied where context does not dictate otherwise.

In one or more examples, the functions described may be implemented in hardware, software, firmware, or any combination thereof. If implemented in software, the functions may be stored, as one or more instructions or code, on and/or transmitted over a computer-readable medium and executed by a hardware-based processing unit. Computer-readable media may include computer-readable storage media, which corresponds to a tangible medium such as data storage media, or communication media including any medium that facilitates transfer of a computer program from one place to another (e.g., pursuant to a communication protocol). In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the terms “processor” or “processing circuitry” as used herein may each refer to any of the foregoing structures or any other structure suitable for implementation of the techniques described. In addition, in some examples, the functionality described may be provided within dedicated hardware and/or software modules. Also, the techniques could be fully implemented in one or more circuits or logic elements.

What is claimed is:

1. A method for performing inference-based move selection in a game-playing system executed by one or more computing devices, the method comprising:
determining, by processing circuitry of the one or more computing devices, a current game position that the processing circuitry represents as digital state data;
generating, for each legal move from the current game position, a predicted opponent move responsive to the legal move using a nominal opponent engine configured to receive the digital state data and to output a move predicted to be selected by an opponent;
evaluating, by a position evaluator engine executed by the processing circuitry, each subsequent game position that results from the predicted opponent move to obtain corresponding numerical evaluation values;
determining, based on the numerical evaluation values, a preferred move associated with an optimal evaluation value; and
outputting, by the processing circuitry, the preferred move as control data defining a next move to be executed in the game.

2. The method of claim 1, wherein the processing circuitry executes a model predictive control procedure that iteratively determines the preferred move over a finite prediction horizon.

3. The method of claim 1, wherein the nominal opponent engine generates the predicted opponent move using a deterministic policy corresponding to a predefined opponent configuration.

4. The method of claim 1, wherein the nominal opponent engine generates the predicted opponent move using a stochastic policy that outputs a probability distribution of potential opponent moves and selects a representative move from the distribution.

5. The method of claim 1, further comprising applying a fortified inference procedure that compares the preferred move with a base policy move generated by the position evaluator engine and selects the base policy move when its evaluation value is greater.

6. The method of claim 1, wherein evaluating each subsequent game position further comprises applying a rollout operation that extends simulated play through multiple future positions to refine the numerical evaluation values.

7. The method of claim 1, wherein determining the preferred move comprises identifying a move associated with a minimum cost-to-go estimate determined from the numerical evaluation values.

8. The method of claim 1, wherein the processing circuitry executes the nominal opponent engine and the position evaluator engine in parallel to reduce inference latency.

9. The method of claim 1, wherein the nominal opponent engine and the position evaluator engine are implemented as neural-network models trained through reinforcement learning prior to the inference-based move selection.

10. The method of claim 1, further comprising executing a multistep lookahead process that repeats the generating, evaluating, and determining steps for a defined lookahead depth greater than one.

11. The method of claim 1, further comprising analyzing prior opponent behavior from previous games and adapting configuration parameters of the nominal opponent engine in response to the analyzed behavior.

12. The method of claim 1, wherein the game-playing system performs inference for a two-person zero-sum game selected from the group consisting of chess, Shogi, Xiangqi, Go, Checkers, and Reversi.

13. The method of claim 1, wherein evaluating each subsequent game position comprises performing numerical evaluations for multiple legal moves using distributed processing resources.

14. The method of claim 1, further comprising monitoring elapsed inference time and adjusting weighting parameters applied to the numerical evaluation values to manage computational resources and inference latency.

15. The method of claim 1, wherein outputting the preferred move as control data comprises transmitting digital command data to a game interface that updates a displayed game state or controls a physical game actuator.

16. The method of claim 1, wherein determining the preferred move comprises applying a weighting factor to combine multiple numerical evaluation values respectively generated by a plurality of position evaluator engines, the weighting factor defining a composite evaluation value used to select the preferred move.

17. A system comprising:
processing circuitry;
non-transitory computer-readable storage media; and
instructions that, when executed by the processing circuitry, configure the processing circuitry to:
determine a current game position that the processing circuitry represents as digital state data;
generate, for each legal move from the current game position, a predicted opponent move responsive to the legal move using a nominal opponent engine configured to receive the digital state data and to output a move predicted to be selected by an opponent;
evaluate, using a position evaluator engine executed by the processing circuitry, each subsequent game position that results from the predicted opponent move to obtain corresponding numerical evaluation values;
determine, based on the numerical evaluation values, a preferred move associated with an optimal evaluation value; and
output, by the processing circuitry, the preferred move as control data defining a next move to be executed in the game.

18. The system of claim 17, wherein the processing circuitry executes a model predictive control procedure that iteratively determines the preferred move over a finite prediction horizon.

19. The system of claim 17, wherein the processing circuitry executes the nominal opponent engine and the position evaluator engine in parallel to reduce inference latency.

20. Non-transitory computer-readable storage media comprising instructions that, when executed by processing circuitry, cause the processing circuitry to:
determine a current game position that the processing circuitry represents as digital state data;
generate, for each legal move from the current game position, a predicted opponent move responsive to the legal move using a nominal opponent engine configured to receive the digital state data and to output a move predicted to be selected by an opponent;
evaluate, using a position evaluator engine executed by the processing circuitry, each subsequent game position that results from the predicted opponent move to obtain corresponding numerical evaluation values;
determine, based on the numerical evaluation values, a preferred move associated with an optimal evaluation value; and
output, by the processing circuitry, the preferred move as control data defining a next move to be executed in the game.
